(19) United States
(12) Patent Application Publication
(10) Pub. No.: US 2014/0065977 A1
(43) Pub. Date: Mar. 6, 2014

(54) WIRELESS COMMUNICATION APPARATUS

(71) Applicant: TOSHIBA TEC KABUSHIKI KAISHA, Tokyo (JP)

(72) Inventor: Takayuki Kumagawa, Shizuoka-ken (JP)

(73) Assignee: TOSHIBA TEC KABUSHIKI KAISHA, Tokyo (JP)

(21) Appl. No.: 13/965,397

(22) Filed: Aug. 13, 2013

(30) Foreign Application Priority Data
Aug. 30, 2012 (JP) 2012-189769

(51) Int. Cl. H04B 1/10; H01Q 13/20

(52) U.S. Cl. CPC H04B 1/1027; H01Q 13/203
USPC 455/67.11

(57) ABSTRACT

A wireless communication apparatus detects strength of electric wave which is transmitted from a wireless communication terminal and received through a leaky coaxial cable and executes the data transmission to the wireless communication terminal by transmitting the electric wave from the leaky coaxial cable if the detected strength of the electric wave is equal to or greater than a set value.

### CROSS-REFERENCE TO RELATED APPLICATION

This application is based upon and claims the benefit of priority from Japanese Patent Application No. 2012-189769, filed Aug. 30, 2012, the entire contents of which are incorporated herein by reference.

### FIELD

Embodiments described herein relate to a wireless communication apparatus in which a leaky coaxial cable is used as an antenna.

### BACKGROUND

A wireless LAN area, i.e. a so-called free spot, can be formed around a leaky coaxial cable used as an antenna.

### BRIEF DESCRIPTION OF THE DRAWINGS

FIG. 1 is a diagram illustrating the configuration and a communicable range of a wireless communication apparatus according to one embodiment;

FIG. 2 is a block diagram of an access point according to the embodiment;

FIG. 3 is a flowchart illustrating the control of the access point according to the embodiment;

FIG. 4 is a table showing a relationship between a link speed and a received signal strength according to the embodiment; and

FIG. 5 is a graph illustrating a relationship between the link speed (and the received signal strength) and a communicable distance according to the embodiment.

### DETAILED DESCRIPTION

In accordance with one embodiment, a wireless communication apparatus includes a leaky coaxial cable, a detection module and a control module. The leaky coaxial cable carries out transmission and reception of electric wave. The detection module detects the strength of the electric wave which is transmitted from a wireless communication terminal and received through the leaky coaxial cable. The control module executes data transmission to the wireless communication terminal by transmitting the electric wave from the leaky coaxial cable if the strength of the electric wave detected by the detection module is equal to or greater than a set value.

One embodiment is described below with reference to the accompanying drawings.

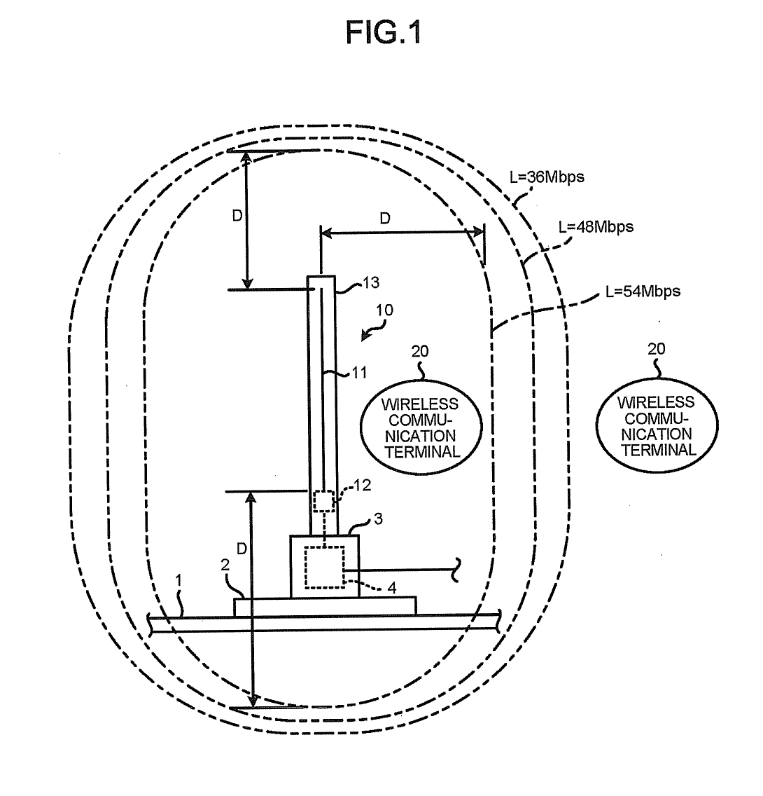

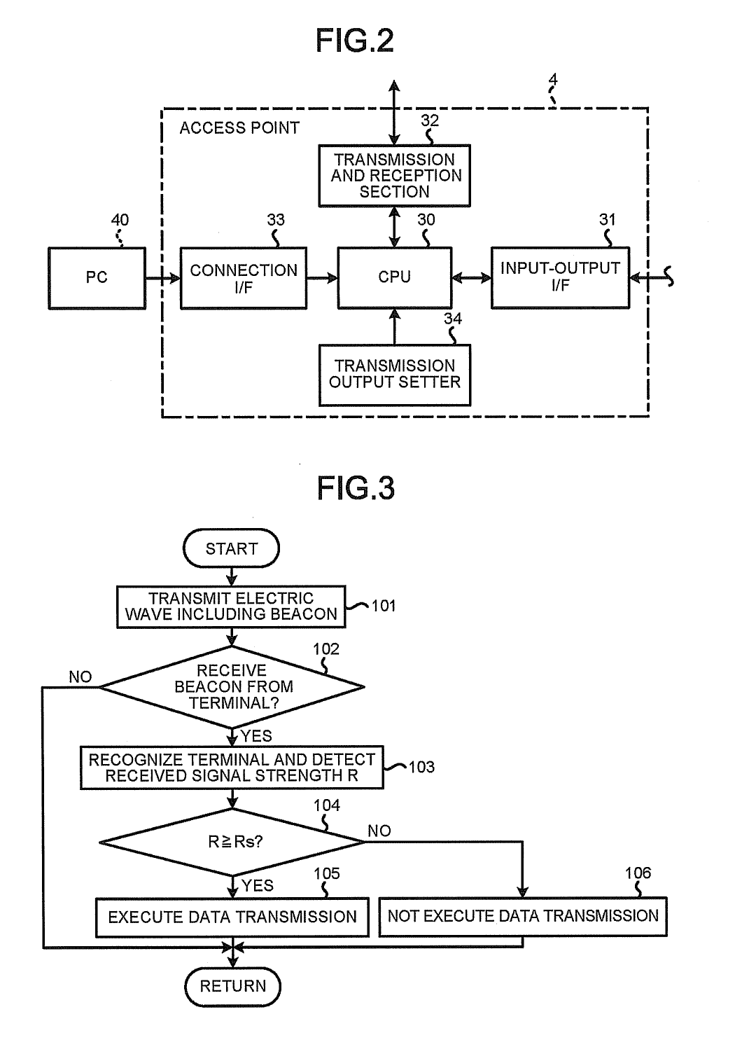

As shown in FIG. 1, a disc-shaped base station 2 is arranged on an installation surface 1 such as a floor, a ceiling, a table and the like. A tower-shaped antenna 10 is vertically arranged on the base station 2 via a cylindrical housing 3. The antenna 10 includes a linear leaky coaxial cable 11 which carries out a transmission and reception of electric wave, an attenuator 12 which attenuates the electric wave (equal to a high frequency electric power supplied to the leaky coaxial cable 11) transmitted from the leaky coaxial cable 11 and a cylindrical cover 13 which covers the leaky coaxial cable 11 and the attenuator 12.

The leaky coaxial cable 11 is also referred to as an LCX cable having a plurality of slots, which transmit (leak) and receive the electric wave, along the axial direction thereof. A wireless LAN area, i.e. a so-called free spot (also referred to as a service area), which is indicated by long dashed double-dotted lines, is formed around the antenna 10 including the leaky coaxial cable 11. A wireless communication terminal 20 can be used to carry out a wireless communication freely in the free spot. The attenuator 12 is attached if the strength of the electric wave transmitted from the leaky coaxial cable 11 is intended to be attenuated or is removed if the strength of the electric wave is not intended to be attenuated. It can be constituted that a plurality of attenuators 12 with different amounts in attenuation are prepared and anyone of which is attached selectively.

The housing 3, in addition to supporting the antenna 10, also houses a transmission/reception unit, i.e. a so-called access point 4 for transmitting and receiving data. The access point 4 includes a CPU 30 which functions as a main control section, an input-output interface 31 which is connected to an external communication network, a transmission/reception section 32 which carries out the transmission=and reception of electric wave, a connection interface 33 for connecting with an external device, and a transmission output setter 34 and the like.

The transmission/reception section 32 superimposes a signal and data responding to the instruction from the CPU 30 on the high frequency electric power to transmit it to the leaky coaxial cable 11, on the one hand, and extracts the signal and data included in the electric wave received through the leaky coaxial cable 11 to supply it to the CPU 30, on the other hand. The connection interface 33 is applied to the connection with the external device such as a personal computer 40. The transmission output setter 34 is applied to setting the high frequency electric power (equal to the strength of the electric wave transmitted from the leaky coaxial cable 11) output from the transmission/reception section 32, and thus includes a volume knob for operation.

The CPU 30 includes the following units (1)-(4) as main functions.

(1) A recognition module which recognizes the wireless communication terminal 20 which exists in a reaching area of the electric wave transmitted from the leaky coaxial cable 11 based on the identification data in a beacon included in the electric wave transmitted from the wireless communication terminal 20. Specifically, a beacon specific to the access point 4 is periodically transmitted by the electric wave transmission from the leaky coaxial cable 11, in response to the beacon transmitted, the electric wave transmitted from the wireless communication terminal 20 and a beacon included in the electric wave are received, and the wireless communication terminal 20 is recognized based on the identification data included in the received beacon. With this recognition, each wireless communication terminal 20 can be recognized respectively, even though a plurality of wireless communication terminals 20 exist in the reaching area of the electric wave.

(2) A detection module which detects the strength of the electric wave which is transmitted from the recognized wireless communication terminal 20 and received through the leaky coaxial cable 11. Specifically, the detection module includes a part of the functions of the recognition module, and detects the signal strength of the beacon, i.e. a so-called received signal strength R (%), included in the electric wave transmitted from the wireless communication terminal 20 in response to the periodical transmission of the beacon in the electric wave received through the leaky coaxial cable 11. The received signal strength R is referred to as an RSSI (Received Signal Strength Indication).

(3) A control unit which executes a data transmission to the recognized wireless communication terminal 20 by the electric wave transmission from the leaky coaxial cable 11 if the received signal strength R detected by the detection module is equal to or greater than the set value Rs, and does not execute the data transmission if the received signal strength R is less the set value Rs, and moreover, variably set the set value Rs according to the input data from the personal computer 40 connected with the connection interface 33. The set value Rs is hereinafter referred to as a transmission rate Rs.

(4) A setting unit module which variably sets the high frequency electric power output from the transmission/reception section 32, i.e. the strength of the electric wave transmitted from the leaky coaxial cable 11, according to the operation of the volume knob of the transmission output setter 34.

Next, the control executed by the CPU 30 of the access point 4 is described with reference to the flowchart in FIG. 3.

The CPU 30 superimposes the beacon specific to the access point 4 on the high frequency electric power, and periodically (for each control loop) transmits the electric wave with the high frequency electric power from the leaky coaxial cable 11 (ACT 101). The transmitted electric wave can reach a point about 50m apart if there is no obstacle and the like.

The wireless communication terminal 20 receiving the electric wave transmits the electric wave including the beacon specific to the wireless communication terminal 20 in response to the beacon included in the received electric wave.

If the electric wave received through the leaky coaxial cable 11 includes the beacon (YES in ACT 102), the CPU 30 recognizes the wireless communication terminal 20 serving as a transmitting source based on the identification data included in the beacon and detects the received signal strength R of the same beacon (ACT 103).

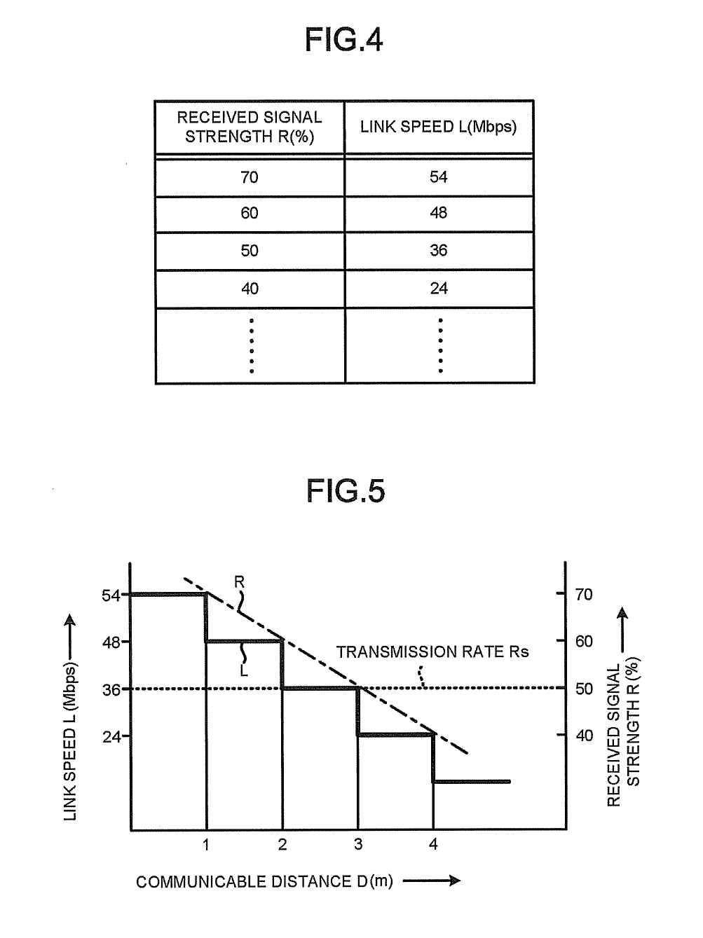

A communication speed, i.e. a so-called link speed L(Mbps), exists between the wireless communication terminal 20 and the access point 4 which are located within the reaching area of the electric wave transmitted from the leaky coaxial cable 11 and, is determined by the transmission loss therebetween. As shown in FIG. 4, the link speed L is in a relationship corresponding to the received signal strength (RSSI) R. For example, in order to obtain the link speed L=54 (Mbps), the received signal strength R must be set to be at least 70(%). In order to obtain the link speed L=48 (Mbps), the received signal strength R must be set to be at least 60(%). Furthermore, in order to obtain the link speed L=36 (Mbps), the received signal strength R must be set to be at least 50(%). Still furthermore, in order to obtain the link speed L=24 (Mbps), the received signal strength R must be set to be at least 40(%).

As shown in FIG. 5, the link speed L is in a relationship corresponding to a communicable distance D. For example, the communicable distance D is about 1m when the link speed L is 54 (Mbps), the communicable distance D is about 2m when the link speed L is 48 (Mbps), the communicable distance D is about 3m when the link speed L is 36 (Mbps) and the communicable distance D is about 4m when the link speed L is 24 (Mbps).

As shown by long dashed double-dotted lines in FIG. 1, the actual communicable distances D respectively extend, in the horizontal direction from the leaky coaxial cable 11, in the upward direction from the upper end of the leaky coaxial cable 11 and in the downward direction from the . The wireless LAN area, i.e. a so-called free spot, is formed in a substantially cylindrical area specified by these communicable distances D.

Returning to FIG. 3, the CPU 30 compares the received signal strength R detected with a preset transmission rate Rs (ACT 104). And then, if the received signal strength R is equal to or greater than the transmission rate Rs (YES in ACT 104), the data transmission to the recognized wireless communication terminal 20 is executed (ACT 105). If the received signal strength R is less than the transmission rate Rs (NO in ACT 104), the data transmission to the recognized wireless communication terminal 20 is not executed (ACT 106).

The transmission rate Rs can be appropriately changed by connecting a personal computer 40 with the connection interface 33 and inputting the set value data through the personal computer 40.

For example, if the transmission rate Rs is set to 50(%), the data transmission is executed to the wireless communication terminal 20 the received signal strength R from which is equal to or greater than 50(%), and the data transmission is not executed to the wireless communication terminal 20 the received signal strength R from which is less than 50(%). In a case that the received signal strength R is equal to or greater than 50(%), the data transmission is executed only to the wireless communication terminal 20 located within 3m within which the link speed L is maintained at 36 (Mbps). The data transmission is not executed to the wireless communication terminal 20 located beyond 3m. However, the data transmission is executed if the wireless communication terminal 20 located beyond 3m moves into the range of 3m. And the data transmission is not executed if the wireless communication terminal 20 located within 3m moves out the range of 3m again.

If the transmission rate Rs is set to 60(%), the data transmission is executed to the wireless communication terminal 20 the received signal strength R from which is equal to or greater than 60(%), and the data transmission is not executed to the wireless communication terminal 20 the received signal strength R from which is less than 60(%). In a case that the received signal strength R is equal to or greater than 60(%), the data transmission is executed only to the wireless communication terminal 20 located within 2m within which the link speed L is maintained at 48 (Mbps). The data transmission is not executed to the wireless communication terminal 20 located beyond 2m. The data transmission is executed, however, if the wireless communication terminal 20 located beyond 2m moves into the range of 2m. And the data transmission is not executed if the wireless communication terminal 20 located within 2m moves out the range of 2m again.

If the transmission rate Rs is set to 70(%), the data transmission is executed to the wireless communication terminal 20 the received signal strength R from which is equal to or greater than 70(%), and the data transmission is not executed to the wireless communication terminal 20 the received signal strength R from which is less than 70(%). In a case that the received signal strength R is equal to or greater than 70(%), the data transmission is executed only to the wireless communication terminal 20 located within 1m within which the link speed L is maintained at 54 (Mbps). The data transmission is not executed to the wireless communication terminal 20 located beyond 1m. The data transmission is executed, however, if the wireless communication terminal 20 located beyond 1m moves into the range of 1m. And the data transmission is not executed if the wireless communication terminal 20 located within 1m moves out the range of 1m again.

In this way, taking the installation place and the service condition and the like of the wireless access point 4 into consideration, the communicable range can be adjusted properly by setting the transmission rate Rs to be a proper value. Even if the electric wave transmitted from the leaky coaxial cable 11 reaches a point about 50m apart, the actual data communication can be exactly restricted in the free spot of an expected range regardless of the reaching distance of the electric wave. The wireless communication with the wireless communication terminal 20 located beyond the free spot is cut off, therefore, the security and reliability of the wireless communication can be also increased.

Further, in the embodiment described above, the description is given referring to the vertically arranged antenna 10 as an example, however, the state in which the antenna 10 is installed in parallel with the floor, the state in which the antenna 10 inclines in a specific angle and the state in which the antenna 10 is hung from the ceiling can be also embodied.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A wireless communication apparatus, comprising:
a leaky coaxial cable configured to carry out transmission and reception of electric wave;
a detection module configured to detect the strength of electric wave that is transmitted from a wireless communication terminal and received through the leaky coaxial cable; and
a control module configured to execute data transmission to the wireless communication terminal by transmitting the electric wave through the leaky coaxial cable if the strength of the electric wave detected by the detection module is equal to or greater than a set value.

2. The wireless communication apparatus according to claim 1, wherein:
the control module executes data transmission to the wireless communication terminal by transmitting the electric wave through the leaky coaxial cable if the detected strength of the electric wave is equal to or greater than the set value which is variably set by the control module according to an input data from an external device and, does not execute data transmission if the detected strength is less than the set value.

3. The wireless communication apparatus according to claim 1, wherein:
the detection module detects the strength of the electric wave which is transmitted from the wireless communication terminal in response to the transmission of electric wave from the leaky coaxial cable within the electric wave received through the leaky coaxial cable.

4. The wireless communication apparatus according to claim 1, wherein:
the detection module periodically transmits the electric wave including a beacon from the leaky coaxial cable, and detects the signal strength of the beacon included in the electric wave which is transmitted from the wireless communication terminal in response to the periodical transmission within the electric wave received through the leaky coaxial cable.

5. The wireless communication apparatus according to claim 1, further comprising:
an attenuator configured to attenuate the electric wave transmitted from the leaky coaxial cable.

6. The wireless communication apparatus according to claim 1, further comprising:
a transmission output setter configured to set the strength of the electric wave transmitted from the leaky coaxial cable.
